(19) United States
(12) Patent Application Publication
(10) Pub. No.: US 2024/0150534 A1
(43) Pub. Date: May 9, 2024

(54) POLYETHYLENE TEREPHTHALATE COMPOSITE MATERIAL CONTAINING GLASS FIBER AND METHOD FOR MANUFACTURING THE SAME

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHUN-LAI CHEN, TAIPEI (TW); Jui-Jung Lin, TAIPEI (TW)

(21) Appl. No.: 18/152,115

(22) Filed: Jan. 9, 2023

(30) Foreign Application Priority Data
Nov. 4, 2022 (TW) 111142099

(51) Int. Cl. C08J 9/00; C08J 5/04

(52) U.S. Cl. CPC C08J 9/0004; C08J 5/043; C08J 9/0014; C08J 9/0066; C08J 2323/06

(57) ABSTRACT

A polyethylene terephthalate composite material containing glass fiber and a method for manufacturing the same are provided. The polyethylene terephthalate composite material includes 40 to 65.5 parts by weight of polyethylene terephthalate, 5 to 40 parts by weight of the glass fiber, and 0.15 to 2.5 parts by weight of a crystallizing agent. The crystallizing agent includes an inorganic crystallizing agent and an organic crystallizing agent, and an added amount of the inorganic crystallizing agent is less than an added amount of the organic crystallizing agent.

### CROSS-REFERENCE TO RELATED PATENT APPLICATION

This application claims the benefit of priority to Taiwan Patent Application No. 111142099, filed on Nov. 4, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyethylene terephthalate composite material and a method for manufacturing the same, and more particularly to a polyethylene terephthalate composite material containing glass fiber and a method for manufacturing the same.

### BACKGROUND OF THE DISCLOSURE

Polyethylene terephthalate (PET) is a crystalline resin widely used in automotive and electronic fields. Compared to polybutylene terephthalate, the polyethylene terephthalate has a low heat distortion temperature and a slow crystallization speed, which are not conducive to processing and applications under high temperatures. Therefore, glass fiber is conventionally added to improve heat resistance and rigidity of the PET resin.

In a plastic injection molding process, crystalline properties of PET products will also be affected by a molding temperature. In general, the plastic injection molding is mainly divided into low-temperature molding at a temperature below 70° C. and high-temperature molding at a temperature above 120° C. Characteristics of the PET products manufactured through the high-temperature molding include having a high crystallinity, a high heat distortion temperature and high rigidity. However, there are also disadvantages that include reduced impact resistance and a longer molding time. The low-temperature molding allows for a shorter molding time, but the PET products manufactured under this condition have a poor crystallinity and a low heat distortion temperature, which are not conducive to processing and applications at a high temperature. If the molding temperature is set between 70° C. and 120° C., problems such as a poor mold releasing property, an insufficient heat distortion temperature and an unstable quality may arise.

Accordingly, how to facilitate crystallization of a polyethylene terephthalate composite material containing the glass fiber (i.e., a surface thereof can be cured when being injected at a molding temperature of from 70° C. to 120° C. without an issue of poor mold release) through an improvement in components or ratios, so as to obtain a composite material having a high heat distortion temperature and shorten an injection molding time, has become one of the important issues to be addressed in the relevant field.

### SUMMARY OF THE DISCLOSURE

In response to the above-referenced technical inadequacies, the present disclosure provides a polyethylene terephthalate composite material containing glass fiber and a method for manufacturing the same.

In one aspect, the present disclosure provides a polyethylene terephthalate composite material containing glass fiber, which includes: 40 to 65.5 parts by weight of polyethylene terephthalate; 5 to 40 parts by weight of the glass fiber; and 0.15 to 2.5 parts by weight of a crystallizing agent. The crystallizing agent includes an inorganic crystallizing agent and an organic crystallizing agent, and an added amount of the inorganic crystallizing agent is less than an added amount of the organic crystallizing agent.

In certain embodiments, the polyethylene terephthalate composite material further includes a modified polyethylene terephthalate, the modified polyethylene terephthalate is made by reacting polyethylene terephthalate with a modifier, and the modifier is adipic acid, polyethylene glycol, a polyether polyol or a polyester polyol.

In certain embodiments, an added amount of the modifier is 4 to 10 parts by weight relative to 100 parts by weight of the polyethylene terephthalate.

In certain embodiments, the modified polyethylene terephthalate, the crystallizing agent, and the glass fiber are melted and mixed at a temperature between 260° C. and 280° C., and are injection molded at a temperature between 80° C. and 100° C., so as to form the polyethylene terephthalate composite material.

In certain embodiments, a crystallinity of the polyethylene terephthalate composite material is greater than 17%.

In certain embodiments, the inorganic crystallizing agent is at least one selected from a group consisting of talc, silicon dioxide (SiO₂), magnesium oxide (MgO), titanium dioxide (TiO₂), barium sulfate (BaSO₄), calcium carbonate (CaCO₃), and calcium silicate.

In certain embodiments, the organic crystallizing agent is at least one selected from a group consisting of benzoate, ethylene diamine, an ionic polymer, alkali metal salt of a polyester oligomer, long-chain linear saturated carboxylic acid sodium salt, long-chain linear saturated carboxylic acid calcium salt, long-chain linear saturated aromatic carboxylic acid metal sodium salt and long-chain linear saturated aromatic carboxylic acid metal magnesium salt.

In certain embodiments, an added amount of the inorganic crystallizing agent is 0.1 to 0.5 parts by weight.

In certain embodiments, an added amount of the organic crystallizing agent is 0.3 to 0.7 parts by weight.

In certain embodiments, the polyethylene terephthalate composite material further includes 3 to 8.5 parts by weight of a flexibilizer.

In certain embodiments, the polyethylene terephthalate composite material further includes 0.1 to 0.5 parts by weight of an antioxidant.

In certain embodiments, the polyethylene terephthalate composite material further includes 0.1 to 1 parts by weight of a processing aid.

In certain embodiments, the polyethylene terephthalate composite material further includes 10 to 25 parts by weight of a flame retardant.

In certain embodiments, the flame retardant is phosphorus flame retardant and nitrogen flame retardant, and a ratio of the phosphorus flame retardant and the nitrogen flame retardant is 1:1 to 1:3.

In another aspect, the present disclosure provides a method for manufacturing a polyethylene terephthalate composite material containing glass fiber. The method includes: reacting polyethylene terephthalate with a modifier to form a modified polyethylene terephthalate; melting and mixing 40 to 65.5 parts by weight of the polyethylene terephthalate, 5 to 10 parts by weight of the modified polyethylene terephthalate, 0.15 to 2.5 parts by weight of a crystallizing agent, and 5 to 40 parts by weight of the glass fiber at a temperature between 260° C. and 280° C., in which the crystallizing agent includes an inorganic crystallizing agent and an organic crystallizing agent, and an added amount of the inorganic crystallizing agent is less than an added amount of the organic crystallizing agent; and performing an injection molding process at a temperature between 80° C. and 100° C., so as to form the polyethylene terephthalate composite material.

In certain embodiments, a heat distortion temperature of the polyethylene terephthalate composite material is 210° C. to 220° C.

In certain embodiments, an impact strength of the polyethylene terephthalate composite material is higher than 6.5 kg-cm/cm.

Therefore, in the polyethylene terephthalate composite material containing the glass fiber and the method for manufacturing the same provided by the present disclosure, by virtue of “the crystallizing agent including an inorganic crystallizing agent and an organic crystallizing agent” and “an added amount of the inorganic crystallizing agent being less than an added amount of the organic crystallizing agent,” the polyethylene terephthalate composite material containing the glass fiber can be rapidly crystallized and an injection molding time can be reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

An embodiment of the present disclosure provides a polyethylene terephthalate composite material containing glass fiber, which mainly includes polyethylene terephthalate, the glass fiber, and a crystallizing agent. Polyethylene terephthalate is made by pure terephthalic acid (PTA) and ethylene glycol (EG) through a condensation reaction. In order for the polyethylene terephthalate to have an improved nucleation effect (so as to reduce an amount of the crystallizing agent subsequently used and further avoid decreased impact resistance), the polyethylene terephthalate used in the present disclosure can be a combination of polyethylene terephthalate and modified polyethylene terephthalate. The modified polyethylene terephthalate is made by reacting the polyethylene terephthalate with adipic acid, polyethylene glycol, a polyether polyol or a polyester polyol. The above-mentioned polyester polyol includes a conventional polyester polyol, a polycaprolactone polyol, and a polycarbonate diol. In the embodiment of the present disclosure, an intrinsic viscosity (IV value) of the polyethylene terephthalate is between 0.65 dL/g and 0.95 dL/g, and more preferably between 0.75 dL/g and 0.85 dL/g (e.g., about 0.80 dL/g).

A raw material of the modified polyethylene terephthalate used in the present disclosure is esterified and then polymerized. Specifically, the polyethylene terephthalate is added into an esterification tank for esterification. After the esterification is carried out for a period of time, a suitable or an appropriate amount of additives may be added into the esterification tank. The additives may include an antioxidant, a stabilizing agent and/or a polymerization catalyst. Subsequently, an esterification product is moved into a polymerization tank for polymerization. The polymerization includes pre-polymerization and/or main polymerization. For example, the pre-polymerization is to decrease an air pressure in the tank over a period of time. The air pressure in the tank can be reduced from a constant pressure to 10 torr by pumping. The air pressure can be further reduced to be less than 10 torr (such as 1 torr or approximately 1 torr). The main polymerization is to heat up a substance in the tank under a low pressure. Under the condition of the air pressure being lower than 1 torr, the polymerization is carried at a temperature of 280° C. until the substance in the tank has a corresponding intrinsic viscosity. Subsequently, the air pressure in the tank can be increased (by being inflated with nitrogen). Through a granulation method commonly used for polymer pellets, the substance in the tank can be extruded and pelletized to form polyester pellets.

Table 1 shows physical properties of the modified polyethylene terephthalate and a conventional polyethylene terephthalate (unmodified).

TABLE 1

| | | | | conventional | | | | | |
|---|---|---|---|---|---|---|---|---|---|
| PET | | | | PET | | modified PET | | | |
| conventional | | parts | PTA + EG | — | | 100 | | 100 | |
| PET | | by | | | | | | | |
| modified | diol | weight | PEG | | | 4 | | 4 | |
| | | | EG | | | — | | 10 | |
| | talc | | — | | | 0.5 | | 0.5 | |
| | powder | | | | | | | | |
| Physical | DSC | heating/cooling rate | | 20° C. | 100° C. | 20° C. | 100° C. | 20° C. | 100° C. |
| property | | (° C./min) | | | | | | | |
| analysis | | heating | Tg(° C.) | 76 | — | 65 | — | 70 | — |
| | | | Tm(° C.) | 255 | 258 | 248 | 253 | 241 | 254 |
| | | cooling | Tc(° C.) | 181 | 182 | 209 | 193 | 193 | 172 |
| | | | Δ Hc(J/g) | 48 | 14 | 48 | 44 | 46 | 36 |

| | | | | | | |
|---|---|---|---|---|---|---|
| Δ T(° C.) | 74 | 76 | 39 | 60 | 48 | 82 |
| undercooling degree | | | | | | |
| t_{1/2}(min) half time | 0.72 | 0.26 | 0.30 | 0.15 | 0.49 | 0.26 |
| of crystallization | | | | | | |

| | | | |
|---|---|---|---|
| storage modulus (×10⁸ Pa) | 1.57 | 1.91 | 1.69 |
| IV(dl/g) | 0.76 | 0.76 | 0.76 |
| hygroscopicity (%) | 0.42 | 0.43 | 0.45 |

DSC: Differential scanning calorimetry; Tg: glass transition temperature; Tm: melting temperature; Tc: critical temperature; ΔHc: endothermic energy amount; IV: intrinsic viscosity.

As shown in Table 1, a half time of crystallization of modified polyethylene terephthalate is less than a half time of crystallization of conventional polyethylene terephthalate. That is, the modified polyethylene terephthalate has shorter crystallization time and further reduces an added amount of crystallizing agent.

In the present disclosure, an added amount of the polyethylene terephthalate in a composition may be 40 parts by weight, 41 parts by weight, 42 parts by weight, 43 parts by weight, 44 parts by weight, 45 parts by weight, 46 parts by weight, 47 parts by weight, 48 parts by weight, 49 parts by weight, 50 parts by weight, 51 parts by weight, 52 parts by weight, 53 parts by weight, 54 parts by weight, 55 parts by weight, 56 parts by weight, 57 parts by weight, 58 parts by weight, 59 parts by weight, 60 parts by weight, 61 parts by weight, 62 parts by weight, 63 parts by weight, 64 parts by weight, 65 parts by weight, or 65.5 parts by weight. When the added amount of the polyethylene terephthalate is less than 40 parts by weight, an injection processing ability of the polyethylene terephthalate composition is poor. When the added amount of the polyethylene terephthalate is higher than 65.5 parts by weight, a crystalline property of the polyethylene terephthalate composition is poor.

The glass fiber can be silicate glass, borosilicate glass, E glass, S glass, etc., or can be other glass fiber for manufacturing long fiber or short fiber. In one embodiment of the present disclosure, a fiber diameter of the glass fiber is 10 μm to 24 μm (e.g., 10 μm, 13 μm, 17 μm, and 24 μm). In the present disclosure, an added amount of the glass fiber may be 5 to 50 parts by weight (e.g., 5 parts by weight, 10 parts by weight, 15 parts by weight, 20 parts by weight, 25 parts by weight, 30 parts by weight, 35 parts by weight, 40 parts by weight, 45 parts by weight, or 60 parts by weight). When the added amount of the glass fiber is less than 5 parts by weight, a strength of the polyethylene terephthalate composition is insufficient. When the added amount of the glass fiber is higher than 50 parts by weight, an injection ability of the polyethylene terephthalate composition is poor, such that an appearance of a product surface is poor.

An added amount of the crystallizing agent may be 0.15 parts by weight, 0.2 parts by weight, 0.3 parts by weight, 0.4 parts by weight, 0.5 parts by weight, 0.6 parts by weight, 0.7 parts by weight, 0.8 parts by weight, 0.9 parts by weight, 1 part by weight, 1.1 parts by weight, 1.2 parts by weight, 1.3 parts by weight, 1.4 parts by weight, 1.5 parts by weight, 1.6 parts by weight, 1.7 parts by weight, 1.8 parts by weight, 1.9 parts by weight, 2 parts by weight, 2.1 parts by weight, 2.2 parts by weight, 2.3 parts by weight, 2.4 parts by weight, or 2.5 parts by weight. When the added amount of the crystallizing agent is less than 0.15 parts by weight, a crystallinity of the polyethylene terephthalate composition is insufficient. When the added amount of the crystallizing agent is higher than 2.5 parts by weight, the impact resistance of a finished product of the polyethylene terephthalate composition is decreased. In one exemplary embodiment of the present disclosure, the added amount of the crystallizing agent does not exceed 1 part by weight.

It should be noted that the crystallizing agent used in the present disclosure includes an inorganic crystallizing agent and an organic crystallizing agent, and an added amount of the inorganic crystallizing agent is less than an added amount of the organic crystallizing agent. When the inorganic crystallizing agent and the organic crystallizing agent are used at the same time in a specific ratio, the polyethylene terephthalate composite material can be injection molded at a molding temperature of from 70° C. to 120° C. (preferably from 80° C. to 120° C.), so that the obtained polyethylene terephthalate can have a heat distortion temperature greater than 200° C. In one exemplary embodiment of the present disclosure, a content ratio of the inorganic crystallizing agent to the organic crystallizing agent is 1:2.

Further, the inorganic crystallizing agent is at least one selected from a group consisting of talc, silicon dioxide (SiO₂), magnesium oxide (MgO), titanium dioxide (TiO₂), barium sulfate (BaSO₄), calcium carbonate (CaCO₃), and calcium silicate. An added amount of the inorganic crystallizing agent may be 0.1 to 0.5 parts by weight (e.g., 0.1 parts by weight, 0.2 parts by weight, 0.3 parts by weight, 0.4 parts by weight, or 0.5 parts by weight). In addition, an average particle size of the inorganic crystallizing agent may be 0.1 lam to 5 μm.

The organic crystallizing agent is at least one selected from a group consisting of benzoate, ethylene diamine, ionic polymer, alkali metal salt of polyester oligomer, long-chain linear saturated carboxylic acid sodium salt, long-chain linear saturated carboxylic acid calcium salt, long-chain linear saturated aromatic carboxylic acid metal sodium salt and long-chain linear saturated aromatic carboxylic acid metal magnesium salt. An added amount of the organic crystallizing agent may be 0.3 to 0.7 parts by weight (e.g., 0.3 parts by weight, 0.4 parts by weight, 0.5 parts by weight, 0.6 parts by weight, or 0.7 parts by weight).

In one embodiment, the polyethylene terephthalate composite material of the present disclosure may further include flexibilizer for reducing brittleness of PET materials and improving impact resistance of the PET materials, so as to increase a flexibility of the composition after being injection molded. The flexibilizer may be an ethylene-butyl acrylate-glycidyl methacrylate copolymer, an ethylene-methyl acrylate-glycidyl methacrylate copolymer (E-MA-GMA), a polyolefin elastomer grafted with maleic anhydride, polyethylene/polypropylene grafted with maleic anhydride, or SEBS grafted with maleic anhydride. However, the aforementioned examples are provided for illustrative purposes only, and are not to be construed as limiting the scope of the present disclosure.

In the present disclosure, an added amount of the flexibilizer may be 3 parts by weight, 3.5 parts by weight, 4 parts by weight, 4.5 parts by weight, 5 parts by weight, 5.5 parts by weight, 6 parts by weight, 6.5 parts by weight, 7 parts by weight, 7.5 parts by weight, 8 parts by weight, or 8.5 parts by weight. When the added amount of the flexibilizer is less than 3 parts by weight, the PET material is brittle and the impact resistance of the PET material is insufficient. When the added amount of the flexibilizer is higher than 8.5 parts by weight, rigidity of the PET material is insufficient, thereby resulting in a decrease in a bending strength.

In one embodiment, the polyethylene terephthalate composite material of the present disclosure may further include an antioxidant, so as to slow or prevent oxidation and avoid deterioration or degradation of the polyethylene terephthalate composition during processing or exposure to harsh environments. The antioxidant can be at least one selected from a group consisting of tetrakis (3,5-di-tert-butyl-4-hydroxy) pentaerythritol phenylpropionate, (tris (2,4-di-tert-butyl) phenyl phosphite, and 3-(3,5-di-tert-butyl-4-hydroxyphenyl) octadecyl propionate. However, the aforementioned examples are provided for illustrative purposes only, and are not to be construed as limiting the scope of the present disclosure.

In the present disclosure, an added amount of the antioxidant in the composition may be 0.1 parts by weight, 0.2 parts by weight, 0.3 parts by weight, 0.4 parts by weight, or 0.5 parts by weight. When the added amount of the antioxidant is less than 0.1 parts by weight, the PET does not have sufficient heat resistance and will decompose easily. When the added amount of the antioxidant is more than 0.5 parts by weight, protection against heat may be increased, but the costs are also increased (not economically beneficial).

In one embodiment, the polyethylene terephthalate composite material of the present disclosure may further include a processing aid, such as a lubricant, a UV absorber, a flow modifier, a crosslinking agent, a coupling agent (e.g., a silane coupling agent and a titanate coupling agent). An added amount of the processing aid in the composition may be 0.1 parts by weight, 0.2 parts by weight, 0.3 parts by weight, 0.4 parts by weight, 0.5 parts by weight, 0.6 parts by weight, 0.7 parts by weight, 0.8 parts by weight, 0.9 parts by weight, or 1 part by weight.

In one embodiment, the polyethylene terephthalate composite material of the present disclosure may further include a flame retardant, so as to increase flame resistance of the composition. The flame retardant may be an organic flame retardant and an inorganic flame retardant. The organic flame retardant can be a phosphorus flame retardant, melamine salt of pentaerythritol phosphate (MPP), ammonium polyphosphate (APP), or melaminecyanurate (MCA). The inorganic flame retardant can be one or more selected from antimony trioxide, zinc borate. The above-mentioned inorganic flame retardant has a good thermal stability, and can be used in cooperation with the organic flame retardant.

In one exemplary embodiment of the present disclosure, the flame retardant can be a phosphorus nitrogen flame retardant. That is, the phosphorus flame retardant and the nitrogen flame retardant are mixed at a content ratio of from 1:1 to 1:3 (preferably 1:2), so as to provide improved flame retardant properties for the polyethylene terephthalate composite material of the present disclosure. It is worth mentioning that, since the flame retardant includes phosphorus and nitrogen, a thermal decomposition temperature of the phosphorus nitrogen flame retardant is greater than 200° C. (e.g., a commercially available Clariant OP series).

### Method for Manufacturing Polyethylene Terephthalate Composite Material Containing Glass Fiber

Specific steps for manufacturing the polyethylene terephthalate composite material containing the glass fiber of the present disclosure include: mixing the polyethylene terephthalate, the inorganic crystallizing agent, the organic crystallizing agent, the flexibilizer, the antioxidant, the processing aid, the flame retardant, and the glass fiber at 260° C. and 280° C.; sequentially feeding the raw materials into a twin-screw extruder for extrusion and granulation; and injection molding at a molding temperature of 90° C. Accordingly, the polyethylene terephthalate composite material can be formed and undergo physical property tests.

A test procedure of the heat distortion temperature is carried out in accordance with the ASTM D648 standard. When measuring the heat distortion temperature, a sample is placed on two supporting points, and a specific gravity is applied to a middle position of the sample, so that an internal stress at an outermost edge of the middle position of the sample is 0.46 Mpa (66 psi) or 1.82 Mpa (264 psi). Then, the entire setup is submerged in an oil bath heated at 2° C. per min. When a deflection of the pressed middle position of the sample is 0.25 mm, a temperature is measured as the heat distortion temperature.

In order to demonstrate that the composition of the present disclosure can shorten a crystallization speed and obtain a high heat distortion temperature at the same time, the following Examples and Comparative Examples are prepared. According to the above-mentioned method, the materials obtained by injection molding will be tested for their physical properties. However, the present disclosure is not limited thereto.

### Example 1

In Example 1, the polyethylene terephthalate composite material includes: 46.4 parts by weight of the polyethylene terephthalate, 10 parts by weight of the modified PET, 30 parts by weight of the glass fiber, 0.2 parts by weight of the inorganic crystallizing agent, 0.5 parts by weight of the organic crystallizing agent, 5 parts by weight of the flexibilizer, 0.45 parts by weight of the antioxidant, 0.6 parts by weight of the processing aid, 10 parts by weight of the phosphorus flame retardant, 5 parts by weight of the nitrogen flame retardant, 0.15 parts by weight of the lubricant, and 1 part by weight of a black masterbatch.

### Example 2

In Example 2, the polyethylene terephthalate composite material includes: 41.4 parts by weight of the polyethylene terephthalate, 5 parts by weight of the modified PET, 30 parts by weight of the glass fiber, 0.2 parts by weight of the inorganic crystallizing agent, 0.5 parts by weight of the organic crystallizing agent, 5 parts by weight of the flexibilizer, 0.45 parts by weight of the antioxidant, 0.6 parts by weight of the processing aid, 10 parts by weight of the phosphorus flame retardant, 5 parts by weight of the nitrogen flame retardant, 0.15 parts by weight of the lubricant, and 1 part by weight of the black masterbatch.

### Example 3

In Example 3, the polyethylene terephthalate composite material includes: 36.4 parts by weight of the polyethylene terephthalate, 30 parts by weight of the glass fiber, 0.2 parts by weight of the inorganic crystallizing agent, 0.5 parts by weight of the organic crystallizing agent, 5 parts by weight of the flexibilizer, 0.45 parts by weight of the antioxidant, 0.6 parts by weight of the processing aid, 10 parts by weight of the phosphorus flame retardant, 5 parts by weight of the nitrogen flame retardant, 0.15 parts by weight of the lubricant, and 1 part by weight of the black masterbatch.

### Comparative Example 1

In Comparative Example 1, the polyethylene terephthalate composite material includes: 46.65 parts by weight of the polyethylene terephthalate, 30 parts by weight of the glass fiber, 0.7 parts by weight of the organic crystallizing agent, 5 parts by weight of the flexibilizer, 0.45 parts by weight of the antioxidant, 1 part by weight of the processing aid, 10 parts by weight of the phosphorus flame retardant, 5 parts by weight of the nitrogen flame retardant, 0.2 parts by weight of the lubricant, and 1 part by weight of the black masterbatch.

### Comparative Example 2

In Comparative Example 2, the polyethylene terephthalate composite material includes: 46.85 parts by weight of the polyethylene terephthalate, 30 parts by weight of the glass fiber, 0.5 parts by weight of the inorganic crystallizing agent, 5 parts by weight of the flexibilizer, 0.45 parts by weight of the antioxidant, 1 part by weight of the processing aid, 10 parts by weight of the phosphorus flame retardant, 5 parts by weight of the nitrogen flame retardant, 0.2 parts by weight of the lubricant, and 1 part by weight of the black masterbatch.

### Comparative Example 3

In Comparative Example 3, the polyethylene terephthalate composite material includes: 46.15 parts by weight of the polyethylene terephthalate, 30 parts by weight of the glass fiber, 0.5 parts by weight of the inorganic crystallizing agent, 0.7 parts by weight of the organic crystallizing agent, 5 parts by weight of the flexibilizer, 0.45 parts by weight of the antioxidant, 1 part by weight of the processing aid, 10 parts by weight of the phosphorus flame retardant, 5 parts by weight of the nitrogen flame retardant, 0.2 parts by weight of the lubricant, and 1 part by weight of the black masterbatch.

### Experimental Results and Discussion

The physical properties of the above-mentioned embodiments and comparative embodiments are shown in Table 2 below:

TABLE 2

| unit of measurement: parts by | | Example | Example | Example | Comparative | Comparative | Comparative |
|---|---|---|---|---|---|---|---|
| weight | | 1 | 2 | 3 | Example 1 | Example 2 | Example 3 |
| polyethylene terephthalate | | 46.4 | 41.4 | 36.4 | 46.65 | 46.85 | 46.15 |
| modified PET | | 10 | 5 | 0 | 0 | 0 | 0 |
| flexibilizer | | 5 | 5 | 5 | 5 | 5 | 5 |
| lubricant | | 0.15 | 0.15 | 0.15 | 0.2 | 0.2 | 0.2 |
| antioxidant | | 0.45 | 0.45 | 0.45 | 0.45 | 0.45 | 0.45 |
| inorganic crystallizing agent | | 0.2 | 0.2 | 0.2 | — | 0.5 | 0.5 |
| organic crystallizing agent | | 0.5 | 0.5 | 0.5 | 0.7 | — | 0.7 |
| processing aid | | 0.6 | 0.6 | 0.6 | 1.0 | 1.0 | 1.0 |
| glass fiber | | 30 | 30 | 30 | 30 | 30 | 30 |
| phosphorus flame retardant | | 10 | 10 | 10 | 10 | 10 | 10 |
| (A230) | | | | | | | |
| nitrogen flame retardant | | 5 | 5 | 5 | 5 | 5 | 5 |
| (MCA) | | | | | | | |
| black masterbatch | | 1 | 1 | 1 | 1 | 1 | 1 |
| physical | impact strength | 6.88 | 6.75 | 6.85 | 6.35 | 6.23 | 4.33 |
| properties | (kg-cm/cm) | | | | | | |
| (molding | tensile strength | 97.85 | 95.65 | 95.69 | 77.53 | 89.36 | 74.99 |
| temperature: | (MPa) | | | | | | |
| 90° C.) | rate of | 3.11 | 3.12 | 3.26 | 3.05 | 3.51 | 2.99 |
| | elongation (%) | | | | | | |
| | bending strength | 165.7 | 161.3 | 163.3 | 140.6 | 139.2 | 158.3 |
| | (MPa) | | | | | | |
| | flexural | 9667 | 9841 | 9569 | 8842 | 8214 | 10315 |
| | modulus (MPa) | | | | | | |
| | heat distortion | 215.5 | 217.8 | 211.5 | 197.8 | 171.5 | 206.5 |
| | temperature | | | | | | |
| | 1.8 MPa (° C.) | | | | | | |
| | flame retardance | V0 | V0 | V0 | V0 | V0 | V0 |
| | ( 1/32 inch) | | | | | | |
| | MI | 31.8 | 34.2 | 37.8 | 41.8 | 40.6 | 50.3 |
| | (275° C./2.16 | | | | | | |
| | kgf) | | | | | | |
| DSC | Tc (° C.) | 209.1 | 200.7 | 203.7 | 184 | 182.6 | 196 |
| | Tm (° C.) | 253.4 | 251.1 | 247.7 | 231.7 | 230.6 | 249.8 |
| | ΔTc | 44.2 | 50.3 | 52.9 | 47.7 | 48 | 53.8 |
| | (Tm − Tc, ° C.) | | | | | | |
| | half time of | 0.8 | 1.02 | 1.03 | 1.05 | 1.11 | 1.07 |
| | crystallization | | | | | | |
| | t½ (min), | | | | | | |
| | 20° C./min | | | | | | |
| | crystallinity (%) | 22.2 | 22.19 | 17.62 | 13.05 | 13.63 | 22.11 |

| | | | | | | |
|---|---|---|---|---|---|---|
| release properties (molding | successful | successful | successful | mold | mold | partly mold |
| temperature: 90° C.) | mold release | mold release | mold release | sticking | sticking | sticking |

DSC: Differential scanning calorimetry; MI: Melt Flow Index; Tm: melting temperature; Tc: critical temperature; ΔHc: endothermic energy amount.

As shown in Examples 1 to 3, a composition including modified polyethylene terephthalate can obtain a polyethylene terephthalate composite material with shorter crystallization time. In addition, the polyethylene terephthalate composite material containing glass fiber provided in the present invention uses both inorganic crystallizing agent and organic crystallizing agent, so that the obtained polyethylene terephthalate can be injection molded at a molding temperature of 90° C. and has a heat distortion temperature higher than 200° C. Although Comparative Example 3 also uses an inorganic crystallization agent and an organic crystallization agent, Comparative Example 3 does not add modified PET and needs to add more crystallization agent, which leads to a decrease in impact resistance.

### Beneficial Effects of the Embodiments

In conclusion, in the polyethylene terephthalate composite material containing the glass fiber and the method for manufacturing the same provided by the present disclosure, by virtue of “the crystallizing agent including an inorganic crystallizing agent and an organic crystallizing agent” and “an added amount of the inorganic crystallizing agent being less than an added amount of the organic crystallizing agent,” the polyethylene terephthalate composite material containing the glass fiber can be rapidly crystallized and an injection molding time can be reduced.

Moreover, when non-modified polyethylene terephthalate is used as the raw material, it is necessary to add more inorganic and organic crystallizing agents for achieving a certain crystallization effect. In the polyethylene terephthalate composite material containing the glass fiber provided by the present disclosure, by virtue of “40 to 65.5 parts by weight of polyethylene terephthalate and 5 to 10 parts by weight of modified polyethylene terephthalate” a used amount of the inorganic and organic crystallizing agents can be reduced (which is economically beneficial).

Further, in the polyethylene terephthalate composite material containing the glass fiber and the method for manufacturing the same provided by the present disclosure, by virtue of “40 to 65.5 parts by weight of polyethylene terephthalate, 5 to 10 parts by weight of modified polyethylene terephthalate, 5 to 40 parts by weight of the glass fiber, and 0.15 to 2.5 parts by weight of a crystallizing agent,” said polyethylene terephthalate composite material can be injection molded at a molding temperature of from 70° C. to 120° C., so that the obtained polyethylene terephthalate has a heat distortion temperature higher than 200° C.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyethylene terephthalate composite material containing glass fiber, comprising:
40 to 65.5 parts by weight of polyethylene terephthalate;
5 to 40 parts by weight of the glass fiber; and
0.15 to 2.5 parts by weight of a crystallizing agent;
wherein the crystallizing agent includes an inorganic crystallizing agent and an organic crystallizing agent, and an added amount of the inorganic crystallizing agent is less than an added amount of the organic crystallizing agent.

2. The polyethylene terephthalate composite material according to claim 1, further comprising a modified polyethylene terephthalate, the modified polyethylene terephthalate is made by reacting polyethylene terephthalate with a modifier, and the modifier is adipic acid, polyethylene glycol, a polyether polyol or a polyester polyol.

3. The polyethylene terephthalate composite material according to claim 2, wherein an added amount of the modifier is 4 to 10 parts by weight relative to 100 parts by weight of the polyethylene terephthalate.

4. The polyethylene terephthalate composite material according to claim 2, wherein the modified polyethylene terephthalate, the crystallizing agent, and the glass fiber are melted and mixed at a temperature between 260° C. and 280° C., and are injection molded at a temperature between 80° C. and 100° C., so as to form the polyethylene terephthalate composite material.

5. The polyethylene terephthalate composite material according to claim 1, wherein a crystallinity of the polyethylene terephthalate composite material is greater than 17%.

6. The polyethylene terephthalate composite material according to claim 1, wherein the inorganic crystallizing agent is at least one selected from a group consisting of talc, silicon dioxide (SiO₂), magnesium oxide (MgO), titanium dioxide (TiO₂), barium sulfate (BaSO₄), calcium carbonate (CaCO₃), and calcium silicate.

7. The polyethylene terephthalate composite material according to claim 1, wherein the organic crystallizing agent is at least one selected from a group consisting of benzoate, ethylene diamine, an ionic polymer, alkali metal salt of a polyester oligomer, long-chain linear saturated carboxylic acid sodium salt, long-chain linear saturated carboxylic acid calcium salt, long-chain linear saturated aromatic carboxylic acid metal sodium salt, and long-chain linear saturated aromatic carboxylic acid metal magnesium salt.

8. The polyethylene terephthalate composite material according to claim 1, wherein an added amount of the inorganic crystallizing agent is 0.1 to 0.5 parts by weight.

9. The polyethylene terephthalate composite material according to claim 1, wherein an added amount of the organic crystallizing agent is 0.3 to 0.7 parts by weight.

10. The polyethylene terephthalate composite material according to claim 1, further comprising 3 to 8.5 parts by weight of a flexibilizer.

11. The polyethylene terephthalate composite material according to claim 1, further comprising 0.1 to 0.5 parts by weight of an antioxidant.

12. The polyethylene terephthalate composite material according to claim 1, further comprising 0.1 to 1 parts by weight of a processing aid.

13. The polyethylene terephthalate composite material according to claim 1, further comprising 10 to 25 parts by weight of a flame retardant.

14. The polyethylene terephthalate composite material according to claim 13, wherein the flame retardant is a phosphorus flame retardant and a nitrogen flame retardant, and a content ratio of the phosphorus flame retardant to the nitrogen flame retardant is 1:1 to 1:3.

15. A method for manufacturing a polyethylene terephthalate composite material containing glass fiber, comprising:
reacting polyethylene terephthalate with a modifier to form a modified polyethylene terephthalate;
melting and mixing 40 to 65.5 parts by weight of the polyethylene terephthalate, 5 to 10 parts by weight of the modified polyethylene terephthalate, 0.15 to 2.5 parts by weight of a crystallizing agent, and 5 to 40 parts by weight of the glass fiber at a temperature between 260° C. and 280° C., wherein the crystallizing agent includes an inorganic crystallizing agent and an organic crystallizing agent, and an added amount of the inorganic crystallizing agent is less than an added amount of the organic crystallizing agent; and
performing an injection molding process at a temperature between 80° C. and 100° C., so as to form the polyethylene terephthalate composite material.

16. The method according to claim 15, wherein a heat distortion temperature of the polyethylene terephthalate composite material is 210° C. to 220° C.

17. The method according to claim 15, wherein an impact strength of the polyethylene terephthalate composite material is higher than 6.5 kg-cm/cm.
